(19) United States
(12) Patent Application Publication
(10) Pub. No.: US 2026/0369078 A1
(43) Pub. Date: Nov. 19, 2026

(54) ROAD SURFACE MARKING IDENTIFICATION METHOD AND ROAD SURFACE MARKING IDENTIFICATION DEVICE

(71) Applicant: Nissan Motor Co., Ltd., Yokohama-shi, Kanagawa (JP)

(72) Inventors: He LIU, Kanagawa (JP); Hirotoshi UEDA, Kanagawa (JP)

(21) Appl. No.: 19/142,983

(22) PCT Filed: Dec. 27, 2022
(86) PCT No.: PCT/JP2022/048424

§ 371 Date: Jun. 25, 2025

(51) Int. Cl. G06V 20/56; G06V 10/75; G06V 10/774; G06V 10/82

(52) U.S. Cl. CPC G06V 20/588; G06V 10/751; G06V 10/774; G06V 10/82

(57) ABSTRACT

A road surface marking identification method and a road surface marking identification device set a label to identify a predetermined marking for each pixel of an image constituting a road surface marking appearing in an image captured around a vehicle. A number of pixels is calculated for each label that have been set in the region of the road surface marking. An evaluation value is calculated for each predetermined marking based on a relationship between the number of pixels for each label. The road surface marking identifies which of the predetermined marking the road surface marking is based on the evaluation value.

This application is a U.S. national stage application of International Application No. PCT/JP2022/048424, filed on Dec. 27, 2022.

### BACKGROUND

### Technical Field

The present invention relates to a road surface marking identification method and a road surface marking identification device.

### Background Information

In order to evaluate the visibility of road surface markings more easily and more stably, a road surface marking image processing device has been proposed that classifies the presence and type of road surface markings by estimating the shape of road surface markings from captured images of roads using a shape estimation unit composed of a convolutional neural network (see Japanese Patent Laid-Open Publication No. 2020-21121, which is hereinafter referred to as Patent Literature 1).

### SUMMARY

According to the Patent Literature 1, since a convolutional neural network is used to classify the presence and type of road surface markings, there is a problem that multiple classes for identifying different road surface markings tend to be calculated in a mixed manner for one single road surface marking.

The present invention has been made in view of the above problem. Its purpose is to provide a road surface marking identification method and a road surface marking identification device that can suppress the mixed calculation of multiple classes for identifying different road surface markings for one single road surface marking.

To solve the above problem, a road surface marking identification method and a road surface marking identification device according to one aspect of the present invention set, for each pixel of an image constituting a road surface marking appearing in an image captured around a vehicle, a label for identifying a predetermined marking, calculate a number of pixels for each label that have been set in the region of the road surface marking, calculate an evaluation value for each predetermined marking based on a relationship between the number of pixels for each label; and identify, based on the evaluation value, which of the predetermined marking the road surface marking is.

According to the present invention, it is possible to suppress the calculation load, facilitate the construction of a hardware environment, and suppress the mixed calculation of multiple classes for identifying different road surface markings for one single road surface marking.

### BRIEF DESCRIPTION OF DRAWINGS

Referring now to the attached drawings which form a part of this original disclosure, illustrative embodiments are shown.

FIG. 1 is a block diagram showing the configuration of a road surface marking identification device according to an embodiment of the present invention.

FIG. 2 is a flowchart showing a processing example of the road surface marking identification device according to an embodiment of the present invention.

FIG. 3 is a diagram showing an example of weight coefficients determined for each label and predetermined marking.

FIG. 4A is a diagram showing an example of an image captured around a vehicle.

FIG. 4B is a diagram showing an example of the distribution of pixels corresponding to road surface markings.

FIG. 4C is a diagram showing an example of the distribution of labels set for each pixel.

FIG. 4D is an enlarged view of a portion related to one road surface marking among those shown in FIG. 4C.

### DETAILED DESCRIPTION OF EMBODIMENTS

Next, embodiments of the present invention will be described in detail with reference to the drawings. In the description, the same reference numerals are given to the same elements to omit redundant explanations.

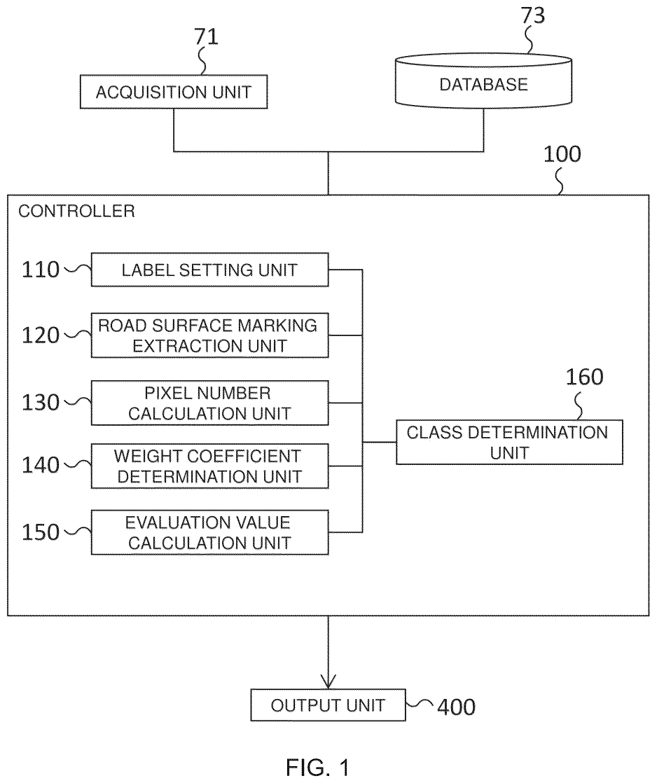

FIG. 1 is a block diagram showing the configuration of the road surface marking identification device according to this embodiment. As shown in FIG. 1, the road surface marking identification device according to this embodiment includes an acquisition unit 71, a database 73, a controller 100, and an output unit 400. The controller 100 is connected to the acquisition unit 71, the database 73, and the output unit 400 via wired or wireless communication paths.

The acquisition unit 71 is connected to an imaging unit (not shown) that captures images around the vehicle, and acquires images captured by the imaging unit. The acquisition unit 71 is connected to the imaging unit via a wired or wireless communication path. For example, the imaging unit includes an imaging element such as a CCD (charge-coupled device), CMOS (complementary metal oxide semiconductor), etc. The images acquired by the acquisition unit 71 are input to the controller 100 and the database 73.

Various road surface markings may appear in the images. Road surface markings may include “white solid line,” “white broken line,” “stop line,” “crosswalk,” “zebra,” “arrow,” “bicycle navigation line,” “blue solid line,” “yellow solid line,” and “others” that are not classified into any of the above, among various possibilities.

Furthermore, “arrows” among road surface markings may include “intersection,” “straight-left,” “left,” “straight,” “right,” “straight-right,” etc. The road surface markings are not limited to the examples given here.

The database 73 stores images acquired by the acquisition unit 71. The database 73 also stores various information used by the controller 100. Examples of the various information used by the controller 100 include the learning model and weight coefficients used by the controller 100, as described later.

The learning model sets labels for each pixel of an image constituting a road surface marking appearing in the image. The learning model may set probabilities for each label. Here, the label identifies which of the multiple predetermined markings the road surface marking is. The probability represents the proportion that the predetermined marking identified by the label set for the pixel matches the road surface marking constituted by the pixel. The relationship between the learning model, labels, and pixels will be described later.

The weight coefficients are coefficients defined for each label and predetermined marking. For example, if the learning model targets N predetermined markings (where N is a natural number), the database 73 stores “N×N” weight coefficients. The weight coefficients will be described later.

The “predetermined markings” mentioned above are those selected in advance from among “road surface markings.” For example, “road surface markings” that are prone to misdetection by the learning model may be selected as “predetermined markings.” In the following description, “intersection,” “straight-left,” “left,” “straight,” “right,” and “straight-right” that constitute “arrows” among “road surface markings” are assumed to be selected as “predetermined markings.”

The database 73 may also store various information generated by the controller 100. For example, the database 73 may store labels and probabilities set for each pixel of an image. The database 73 may also store, for each road surface marking that appears in an image, a class that identifies which of the multiple predetermined markings the road surface marking is.

Additionally, the database 73 may store road information around the vehicle. The road information may be acquired from an external server connected to the road surface marking identification device and stored in the database 73.

The output unit 400 outputs various information generated by the controller 100. For example, the output unit 400 may output the output from the learning model, described later, to the outside.

The controller 100 outputs classes that identify which of the multiple predetermined markings the road surface markings appearing in the image captured around the vehicle are. The functions that the controller 100 has to output classes are described below.

The controller 100 (an example of a control unit or processing unit) is a general-purpose computer that includes a CPU (Central Processing Unit), memory, and an input/output unit. A computer program (information processing program) is installed on the controller 100 to function as part of the road surface marking identification device. By executing the computer program, the controller 100 functions as multiple information processing circuits (110, 120, 130, 140, 150, 160) that the road surface marking identification device has.

Here, an example is shown where the multiple information processing circuits (110, 120, 130, 140, 150, 160) that the road surface marking identification device has are realized by software. However, it is also possible to prepare dedicated hardware to execute each information processing described below and constitute the information processing circuits (110, 120, 130, 140, 150, 160). The multiple information processing circuits (110, 120, 130, 140, 150, 160) may also be constituted by individual hardware.

The controller 100, as multiple information processing circuits (110, 120, 130, 140, 150, 160), includes a label setting unit 110, a road surface marking extraction unit 120, a pixel number calculation unit 130, a weight coefficient determination unit 140, an evaluation value calculation unit 150, and a class determination unit 160.

The label setting unit 110 sets, based on an image captured around the vehicle, labels that identify predetermined markings and probabilities related to those labels for each pixel of the image constituting the road surface marking. Specifically, the label setting unit 110 inputs the image into a pre-set learning model and sets labels and probabilities based on the output values output from the learning model for each pixel of the image.

For example, in the processing of the label setting unit 110, the “output value” output from the learning model when the image is input to the learning model consists of a set of probabilities for each label. Therefore, the label setting unit 110 sets the label corresponding to the maximum probability among the set of probabilities as the label to be set for the pixel of the image. Additionally, the label setting unit 110 sets the maximum probability among the set of probabilities as the probability to be set for the pixel of the image.

The learning model may be a neural network generated through machine learning based on training images and training labels set for each pixel of the training images to identify predetermined markings.

The training images are images captured around the vehicle with training labels that identify road surface markings assigned to each pixel that constitutes the image. The training images may be generated by “annotation,” where a person visually confirms the image and assigns training labels to each pixel that constitutes the image.

Furthermore, the training images may be generated by performing viewpoint conversion based on potential postures that the imaging unit might take on the training images generated by “annotation.” That is, the training images may be obtained by “augmenting” the training images generated by “annotation.”

The neural network generated through machine learning is a model that expresses the relationship between the training images and the training labels assigned to each pixel of the training images. The learning model can perform semantic segmentation on the image by outputting candidates for labels assigned to each pixel when an image is input. The learning model can identify features of road surface markings from the input image, such as type, shape, position, direction, etc.

When the learning model is a neural network, the neural network includes an input layer (or kernel), an output layer where output values are output, and at least one or more hidden layers provided between the input layer and the output layer, with signals propagating in the order of input layer, hidden layers, and output layer.

Each layer-input layer, hidden layers, and output layer-consists of one or more units. Units between layers are connected, and each unit has an activation function (e.g., sigmoid function, rectified linear function, softmax function, etc.). A weighted sum is calculated based on multiple inputs to the unit, and the value of the activation function with the sum as a variable becomes the output of the unit. For example, in machine learning, the weights used to calculate the sum at each unit of the neural network are adjusted as parameters related to the learning model.

When generating a learning model through machine learning, an image is input to the input layer of the neural network that constitutes the learning model. When a training image is input to the input layer, a set of probabilities for each label is output from the output layer. The parameters related to the learning model are adjusted so that the probability corresponding to the training label in the set of probabilities for each label is maximized. Alternatively, when a training image is input to the input layer and a label is output from the output layer, the parameters related to the learning model are adjusted to minimize the difference between the output label and the training label.

When generating a learning model through machine learning, methods such as gradient descent method, stochastic gradient descent method, etc., may be used to minimize the error related to the output of the neural network. Additionally, backpropagation may be used for gradient calculation in the gradient descent method or stochastic gradient descent method.

In machine learning using a neural network, generalization performance (ability to discriminate unknown data) and overfitting (a phenomenon where the model fits the data used to create the learning model but generalization performance does not improve) can be problematic.

Therefore, when generating a learning model through machine learning, techniques such as regularization, which constrains the freedom of weights during learning, may be used to mitigate overfitting. Other techniques may include dropout, which probabilistically selects units in the neural network and disables other units.

Furthermore, techniques such as data regularization, data standardization, data augmentation, etc., may be used to improve generalization performance by eliminating biases in the data.

The road surface marking extraction unit 120 determines connected regions in the image based on the labels set for each pixel of the image and extracts the connected regions as road surface markings. More specifically, the road surface marking extraction unit 120 determines connected regions by grouping adjacent pixels having the same label. In doing so, the road surface marking extraction unit 120 may determine connected regions by performing morphological operations (dilation, erosion, opening, closing) on the image based on the labels.

For example, the road surface marking extraction unit 120 determines connected regions for each label of “white solid line,” “white broken line,” “stop line,” “crosswalk,” “zebra,” “arrow,” “bicycle navigation line,” “blue solid line,” “yellow solid line,” and “others.”

Similarly, the road surface marking extraction unit 120 may determine connected regions for each label of “intersection,” “straight-left,” “left,” “straight,” “right,” and “straight-right.”

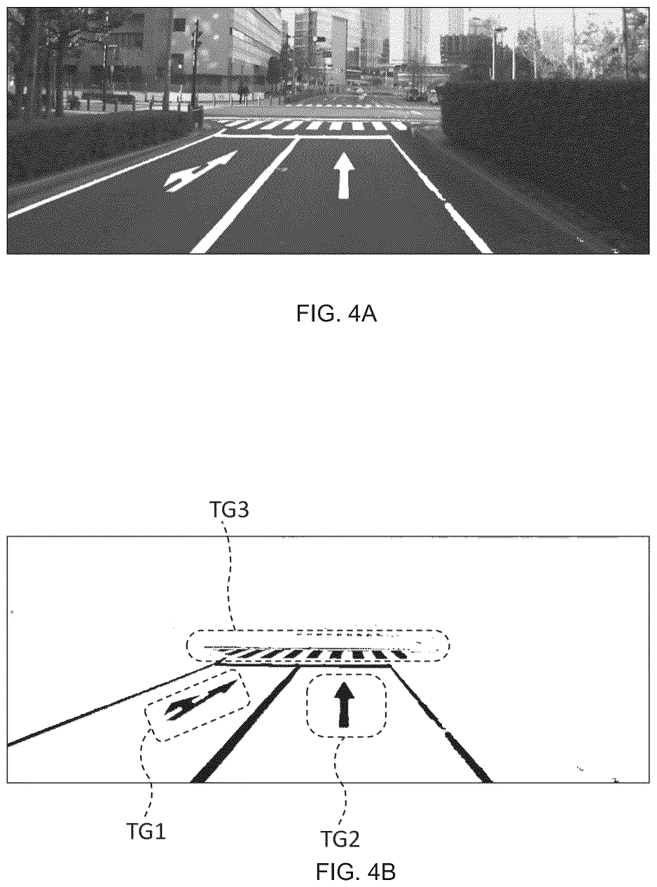

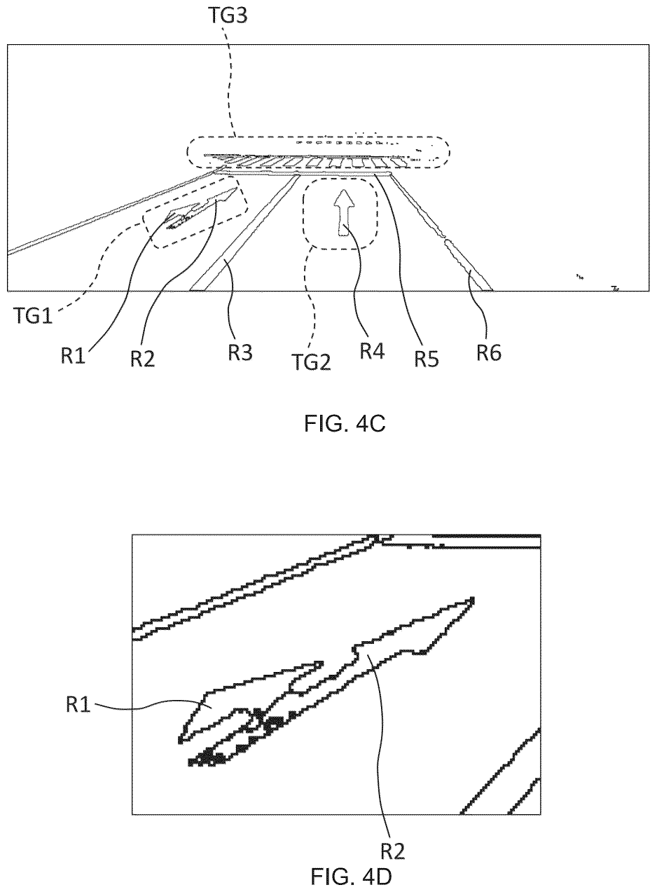

However, due to the accuracy of label setting in the label setting unit 110, a problem may arise where multiple connected regions corresponding to multiple labels for identifying different road surface markings are determined in a mixed manner for a single road surface marking of interest. Such a problem case is explained using FIGS. 4A-4D.

When the label setting unit 110 sets labels for the image shown in FIG. 4A, labels are set for pixels constituting the road surface markings shown in FIG. 4B. In FIG. 4B, road surface markings TG1 to TG3 are shown. Road surface marking TG1 is a road surface marking meaning “straight-left.” Road surface marking TG2 is a road surface marking meaning “straight.” Road surface marking TG3 is a road surface marking meaning “crosswalk.” FIG. 4B shows various road surface markings other than the road surface markings TG1 to TG3, but their explanation is omitted.

The label setting unit 110 may perform label setting as shown in FIG. 4C and FIG. 4D. In FIG. 4C, connected regions R1 to R6 are shown. Pixels constituting connected region R1 are set with a label identifying “straight-left.” Pixels constituting connected region R2 are set with a label identifying “straight.”

In addition, pixels constituting connected regions R3 and R6 are set with a label identifying “white line.” Pixels constituting connected region R4 are set with a label identifying “straight.” Pixels constituting connected region R5 are set with a label identifying “stop line.”

FIG. 4D is an enlarged view of the portion related to road surface marking TG1 in FIG. 4C. Referring to FIG. 4D, it shows how connected regions R1 and R2 are mixed within road surface marking TG1. If the accuracy of label setting in the label setting unit 110 is sufficiently high, a label identifying “straight-left” would be set for all pixels constituting road surface marking TG1. However, when the accuracy of label setting in the label setting unit 110 is not sufficiently high, multiple labels may be set within one road surface marking of interest, as shown in FIG. 4C and FIG. 4D.

Therefore, the road surface marking extraction unit 120 may group labels that are prone to misdetection and determine connected regions by grouping adjacent pixels having the grouped labels. In the above example, the road surface marking extraction unit 120 may group the labels “intersection,” “straight-left,” “left,” “straight,” “right,” and “straight-right” and treat them as the label “arrow.” The road surface marking extraction unit 120 may then determine connected regions by grouping adjacent pixels having the label “arrow.” The labels to be grouped are not limited to the examples given here.

This makes it possible to handle the entire set of pixels with multiple labels set within one road surface marking of interest as a single connected region, enabling correct extraction as one road surface marking.

The pixel number calculation unit 130 calculates, for each road surface marking extracted by the road surface marking extraction unit 120, the number of pixels for each label that have been set.

In many cases, a single label is set for pixels constituting one road surface marking in the image. However, as shown in FIG. 4C and FIG. 4D, there may be cases where multiple labels are set within one single road surface marking of interest. In such cases, the pixel number calculation unit 130 calculates the number of pixels for each label among the multiple labels included in the single road surface marking of interest. The calculated number of pixels for each label is used in the evaluation value calculation unit 150 described later.

Incidentally, if the class of a road surface marking is determined to be the label with the largest number of pixels in the road surface marking, a problem may arise.

For example, suppose the pixel number calculation unit 130 calculates the number of pixels for the label identifying “straight-left” as “367” and the number of pixels for the label identifying “straight” as “552” in road surface marking TG1 shown in FIG. 4C and FIG. 4D. In this case, the label with the largest number of pixels in road surface marking TG1 is the label identifying “straight.” Therefore, the class of road surface marking TG1 would be determined to be “straight.”

However, as shown in FIG. 4B, road surface marking TG1 is a road surface marking meaning “straight-left.” In other words, if the class of road surface marking TG1 is determined to be the label with the largest number of pixels in road surface marking TG1, a problem arises where a class identifying a road surface marking different from the actual road surface marking TG1 is incorrectly determined as the class of road surface marking TG1.

Therefore, a method is needed to accurately determine the class of a road surface marking when multiple labels for identifying different road surface markings are included in one road surface marking of interest. The road surface marking identification device according to this embodiment aims to solve these problems by including the weight coefficient determination unit 140, the evaluation value calculation unit 150, and the class determination unit 160 described below.

The pixel number calculation unit 130 may determine, for each road surface marking, whether multiple labels are assigned to the pixels constituting the image of the road surface marking. The case where multiple labels are assigned to the pixels constituting the image of the road surface marking corresponds to the case where multiple labels for identifying different road surface markings are included in one road surface marking of interest, as described above.

Therefore, the processing by the weight coefficient determination unit 140, the evaluation value calculation unit 150, and the class determination unit 160 to calculate the evaluation value described later may be performed only for the road surface marking determined to have multiple labels attached to the pixels of the image that constitutes the road surface marking.

Additionally, the pixel number calculation unit 130 may determine, for each road surface marking, whether the labels assigned to the pixels constituting the image of the road surface marking are specific labels. Here, the “specific labels” are, for example, labels indicating “road surface markings” that are prone to misdetection. More specifically, the “specific labels” are labels indicating “road surface markings” that display multiple destinations, such as “straight-left,” “straight-right,” etc. The “specific labels” may be determined based on road information around the vehicle. For example, the “specific labels” may be determined based on information such as the number of lanes in the vehicle's own lane, whether it is near an intersection, the route through the intersection, etc., obtained from map data and sensor data as road information around the vehicle.

Then, when it is determined that the label attached to the pixel of the image constituting the road surface marking is the specific label, the processing by the weight coefficient determination unit 140, the evaluation value calculation unit 150, and the class determination unit 160 to calculate the evaluation value described later may be performed only for road surface markings determined to have labels that are specific labels.

The weight coefficient determination unit 140 determines weight coefficients for each label and predetermined marking for each road surface marking. More specifically, the weight coefficient determination unit 140 determines weight coefficients corresponding to predetermined markings for each of the multiple labels included in one road surface marking of interest. That is, the weight coefficient determination unit 140 determines the number of weight coefficients equal to the number of types of predetermined markings for each label.

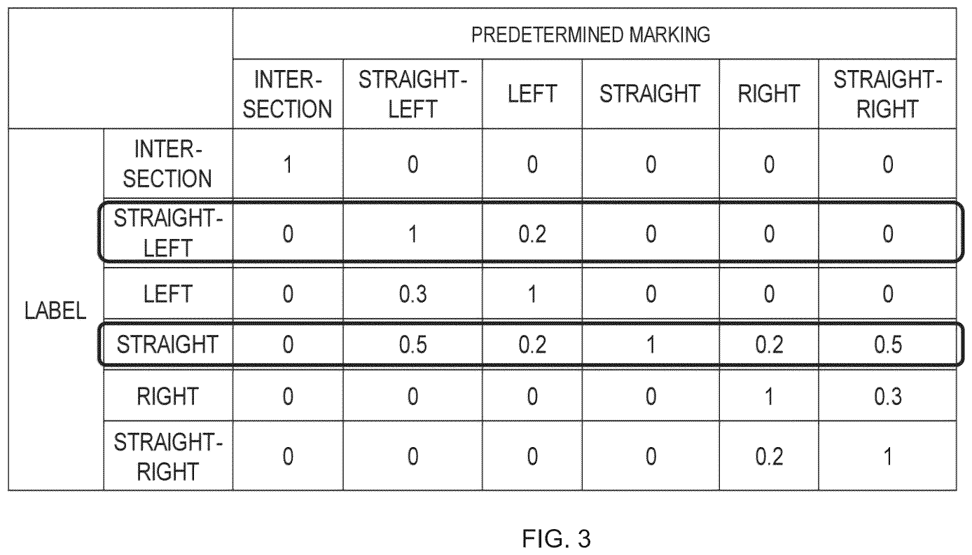

FIG. 3 is a diagram showing an example of weight coefficients determined for each label and predetermined marking. For example, in the case shown in FIG. 4C and FIG. 4D, the weight coefficient determination unit 140 determines the number of weight coefficients equal to the number of types of predetermined markings for the labels “straight-left” and “straight” included in road surface marking TG1. The specific numerical values of the determined weight coefficients are shown in the rows for the labels “straight-left” and “straight” in the table in FIG. 3.

The weight coefficients determined by the weight coefficient determination unit 140 are not limited to the examples shown in FIG. 3. For example, the weight coefficients may be values obtained by changing them in a direction that increases the proportion of output classes matching training classes when the image is a training image, based on pairs of training images and training classes identifying which of the multiple predetermined markings the training road surface markings appearing in the training images are. The weight coefficients may be set in advance based on the pairs of training images and training classes.

For example, the weight coefficients may be obtained by changing them from a predetermined initial value in a direction that increases the proportion of output classes matching training classes for training images, as a result of the processing by the evaluation value calculation unit 150 and the class determination unit 160 described later.

More specifically, the weight coefficients are changed by a unit amount in a direction that increases the proportion of output classes matching training classes for training images. Then, the increase in the proportion of output classes matching training classes when the weight coefficients are changed by a unit amount is monitored. The weight coefficients are repeatedly changed until the increase per unit amount of change in the weight coefficients becomes less than or equal to a predetermined threshold, to obtain the final weight coefficients. These final weight coefficients may be set in advance as the weight coefficients determined by the weight coefficient determination unit 140.

The evaluation value calculation unit 150 calculates an evaluation value for each predetermined marking. For example, the evaluation value calculation unit 150 calculates an evaluation value for each predetermined marking based on the relationship between the number of pixels for each label. The method of calculating the evaluation value is not limited to using the weight coefficients described later, as long as it can appropriately calculate an evaluation value for each predetermined marking when multiple labels are assigned to the pixels constituting the image of the road surface marking.

To calculate the evaluation value, the evaluation value calculation unit 150 may calculate a sum for each predetermined marking by summing the products of the number of pixels and the weight coefficients for each label. The evaluation value calculation unit 150 may then calculate an evaluation value for each predetermined marking by multiplying the sum by a confidence level calculated based on the probability related to the label identifying the predetermined marking. Specifically, the evaluation value for each predetermined marking is calculated by the following equation (1):

D(k)={M(1)×W(1, k)+M(2)×W(2, k)+ . . . +M(N)×W(N, k)}×P(k) (1)
where, assuming that predetermined markings and labels have indices from 1st to Nth, “D(k)” represents the evaluation value of the kth predetermined marking, “M(k)” represents the number of pixels of the kth label, “W(k, l)” represents the weight coefficient for the kth label and lth predetermined marking, and “P(k)” represents the confidence level for the kth predetermined marking.

The evaluation value calculation unit 150 may use the maximum value among the probabilities related to the label as the confidence level for each road surface marking and label.

For example, in the case shown in FIG. 4C and FIG. 4D, the evaluation value calculation unit 150 calculates the sum for the predetermined marking “straight-left” by equation (2):

(Sum)=367×1+552×0.5=643 (2)

The evaluation value calculation unit 150 also calculates the sum for the predetermined marking “straight” by equation (3):

(Sum)=367×0+552×1=552 (3)

If the maximum probability in the pixels with the label “straight-left” set in road surface marking TG1 is “0.9972,” the evaluation value calculation unit 150 calculates the evaluation value for the predetermined marking “straight-left” by the following equation (4):

(Evaluation value)=643×0.9972=642 (4)

If the maximum probability in the pixels with the label “straight” set in road surface marking TG1 is “0.9969,” the evaluation value calculation unit 150 calculates the evaluation value for the predetermined marking “straight” by the following equation (5):

(Evaluation value)=552×0.9969~551 (5)

In the case shown in FIG. 4C and FIG. 4D, the evaluation value calculation unit 150 also calculates sums and evaluation values for the predetermined markings “intersection,” “left,” “right,” and “straight-right” in a similar manner. However, in the case shown in FIG. 4C and FIG. 4D, there are no pixels corresponding to the predetermined markings “intersection,” “left,” “right,” and “straight-right.” Therefore, the confidence levels for these predetermined markings are “0,” and the evaluation values are calculated as “0.”

Additionally, the evaluation value calculation unit 150 may extract labels for which the weight coefficients are greater than a predetermined threshold as “specific labels” and calculate evaluation values only for road surface markings related to these specific labels. In other words, pixels with labels for which the weight coefficients are less than or equal to the predetermined threshold may be excluded from the calculation from the beginning since they have little impact on the sum and evaluation value.

The class determination unit 160 determines a class corresponding to the predetermined marking with the largest evaluation value. The class determination unit 160 then outputs the determined class to the output unit 400.

In the case shown in FIG. 4C and FIG. 4D, the evaluation value calculation unit 150 has calculated the evaluation value for the predetermined marking “straight-left” as “642” and the evaluation value for the predetermined marking “straight” as “551.” Also, the evaluation values for the predetermined markings “intersection,” “left,” “right,” and “straight-right” are calculated as “0.” Therefore, the class determination unit 160 determines that the predetermined marking with the largest evaluation value is “straight-left” and outputs a class identifying “straight-left.”Thus, the problem that occurs when determining the class of a road surface marking based on the label with the most pixels in the road surface marking is solved by instead determining the class of the road surface marking based on the evaluation value.

As an example of a method for calculating an evaluation value for each predetermined marking based on the relationship between the number of pixels for each label, a threshold for the pixel ratio of each label relative to the total number of pixels may be set, and the label may be determined to be the road surface marking if the pixel ratio exceeds the threshold.

For example, in the case shown in FIG. 4C and FIG. 4D, the number of pixels for the label identifying “straight-left” is “367,” the number of pixels for the label identifying “straight” is “552,” and the total number of pixels is “367+552=919,” so the ratio of the number of pixels for the label “straight-left” to the total number of pixels is “367/919.” If the threshold for this ratio is set to 0.3(30%), then since “367/919>0.3,” it may be determined to be “straight-left.”

As an example of a method for calculating an evaluation value for each predetermined marking based on the relationship between the number of pixels for each label, when multiple labels exist, a reference pixel ratio may be set in advance for each combination of multiple labels, and the label with a ratio greater than the reference pixel ratio may be determined to be the road surface marking.

For example, in the case shown in FIG. 4C and FIG. 4D, the number of pixels for the label identifying “straight-left” is “367,” the number of pixels for the label identifying “straight” is “552,” so the ratio of the number of pixels for the label “straight-left” to the number of pixels for the label identifying “straight” is “367/552.” If the threshold for this ratio is set to ⅗(60%), then since “367/552>3/5,” it may be determined to be “straight-left.”

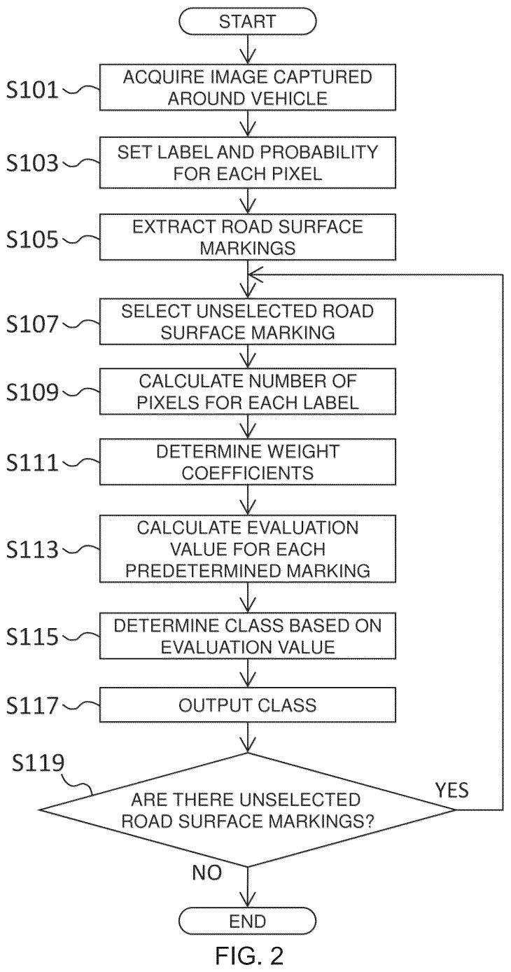

FIG. 2 is a flowchart showing a processing example of the road surface marking identification device according to this embodiment. The processing of the road surface marking identification device shown in FIG. 2 may be repeatedly executed each time an image is input to the controller 100.
In step S101, the acquisition unit 71 acquires an image captured around the vehicle.
In step S103, the label setting unit 110 sets a label identifying a predetermined marking and a probability related to the label for each pixel of the image.
In step S105, the road surface marking extraction unit 120 extracts road surface markings from the image based on the labels.
In step S107, the pixel number calculation unit 130 selects an unselected road surface marking from among the road surface markings extracted by the road surface marking extraction unit 120.
In step S109, the pixel number calculation unit 130 calculates the number of pixels for each label that has been set for the newly selected road surface marking.
In step S111, the weight coefficient determination unit 140 determines weight coefficients for each label and predetermined marking.
In step S113, the evaluation value calculation unit 150 calculates an evaluation value for each predetermined marking.
In step S115, the class determination unit 160 determines a class based on the evaluation value.
In step S117, the class determination unit 160 outputs the determined class.
In step S119, the controller 100 (pixel number calculation unit 130) determines whether there are any unselected road surface markings.

If it is determined that there are unselected road surface markings (in the case of YES in step S119), the process returns to step S107.

On the other hand, if it is determined that there are no unselected road surface markings (in the case of NO in step S119), the processing of the road surface marking identification device shown in FIG. 2 is terminated.

As described in detail above, the road surface marking identification method and the road surface marking identification device according to this embodiment set, for each pixel of an image constituting a road surface marking appearing in an image captured around a vehicle, a label for identifying a predetermined marking, calculate a number of pixels for each label that have been set in the region of the road surface marking, calculate an evaluation value for each predetermined marking based on a relationship between the number of pixels for each label; and identify, based on the evaluation value, which of the predetermined marking the road surface marking is.

This makes it possible to suppress the calculation load, facilitate the construction of a hardware environment, and suppress the mixed calculation of multiple classes for identifying different road surface markings for a single road surface marking.

Furthermore, the road surface marking identification method and road surface marking identification device according to this embodiment may set, based on the image, probabilities related to the labels for each pixel of the image constituting the road surface marking. Weight coefficients may be determined for each label and predetermined marking. An evaluation value for each predetermined marking may be calculated by multiplying a confidence level calculated based on the probability related to the label identifying the predetermined marking by the sum for each predetermined marking obtained by summing the products of the number of pixels and the weight coefficients for each label. A class corresponding to the predetermined marking with the largest evaluation value may then be output.

This suppresses the incorrect determination of a class identifying a road surface marking different from the actual road surface marking as the class of the road surface marking, which would occur if the class of the road surface marking were determined to be the label with the largest number of pixels in the road surface marking.

As a result, it becomes possible to determine the class of a road surface marking with high accuracy.

Additionally, the road surface marking identification method and road surface marking identification device according to this embodiment may set labels and probabilities for each pixel of the image constituting the road surface marking based on output values output for each pixel of the image from a learning model to which the image has been input. Here, the learning model may be a neural network generated through machine learning based on training images and training labels set for each pixel of the training images to identify predetermined markings. This enables semantic segmentation to be performed on the image using the learning model. Features of road surface markings such as type, shape, position, direction, etc., can be identified from the input image.

Furthermore, the road surface marking identification method and road surface marking identification device according to this embodiment may determine connected regions in the image based on the labels set for each pixel of the image and extract the connected regions as road surface markings. This makes it possible to handle the entire set of pixels with multiple labels set within one road surface marking of interest as a single connected region, enabling correct extraction as one road surface marking.

Also, in the road surface marking identification method and road surface marking identification device according to this embodiment, the weight coefficients may be values obtained by changing them in a direction that increases the proportion of output classes matching training classes when the image is a training image, based on pairs of training images and training classes identifying which of the multiple predetermined markings the training road surface markings appearing in the training images are. This makes it possible to determine the class of a road surface marking with high accuracy while suppressing the calculation load without improving the accuracy of the learning model. As a result, it is possible to suppress the mixed calculation of multiple classes for identifying different road surface markings for a single road surface marking.

Furthermore, the road surface marking identification method and road surface marking identification device according to this embodiment may determine, for each road surface marking, whether multiple labels are assigned to the pixels constituting the image of the road surface marking, and calculate the evaluation value only for road surface markings determined to have multiple labels. This can reduce the calculation load when determining the class for a road surface marking.

Also, the road surface marking identification method and road surface marking identification device according to this embodiment may determine, for each road surface marking, whether the labels assigned to the pixels constituting the image of the road surface marking are specific labels, and calculate the evaluation value only for road surface markings determined to have labels that are specific labels. This enables class determination for road surface markings using weight coefficients targeting “road surface markings” that are prone to misdetection. As a result, the calculation load can be reduced. Furthermore, it becomes possible to determine the class of a road surface marking with high accuracy.

Furthermore, in the road surface marking identification method and road surface marking identification device according to this embodiment, the weight coefficients related to the specific labels may be greater than a predetermined threshold. Pixels with labels for which the weight coefficients are less than or equal to the predetermined threshold may be excluded from the calculation from the beginning since they have little impact on the sum and evaluation value. As a result, the calculation load can be reduced.

Also, the road surface marking identification method and road surface marking identification device according to this embodiment may determine the specific labels based on road information around the vehicle. This enables class determination for road surface markings using weight coefficients targeting “road surface markings” that are prone to misdetection. As a result, the calculation load can be reduced. Furthermore, it becomes possible to determine the class of a road surface marking with high accuracy.

Furthermore, the road surface marking identification method and road surface marking identification device according to this embodiment may use the maximum value among the probabilities related to the label as the confidence level for each road surface marking and label. This makes it possible to determine the class of a road surface marking with high accuracy while suppressing the calculation load without improving the accuracy of the learning model. As a result, it is possible to suppress the mixed calculation of multiple classes for identifying different road surface markings for a single road surface marking.

Each function shown in the above embodiment may be implemented by one or more processing circuits. The processing circuits may include a programmed processor, an electric circuit, and also devices such as an application-specific integrated circuit (ASIC) or circuit components arranged to execute the described functions.

Although the contents of the present invention have been described according to the embodiments, it is obvious to those skilled in the art that various modifications and improvements are possible and are not limited to these descriptions. It should not be understood that the statements and drawings that form part of this disclosure limit the present invention. Various alternative embodiments, examples, and operational techniques will be apparent to those skilled in the art from this disclosure.

The present invention naturally includes various embodiments, etc., not described herein. Therefore, the technical scope of the present invention is determined only by the invention-specifying matters according to the appended claims that are reasonable from the above description.

1. A road surface marking identification method for controlling a controller connected to an imager capturing surroundings of a vehicle, the controller that identifies which of a plurality of predetermined marking a road surface marking appearing in an image captured by the imager is, wherein
the controller:
sets, based on the image, a label identifying a predetermined marking for each pixel of the image constituting the road surface marking;
in a region of the road surface marking:
calculates a number of pixels for each label that have been set;
calculates an evaluation value for each predetermined marking based on a relationship between the number of pixels for each of different labels included in an area of the road surface marking; and
identifies, based on the evaluation value, which of the predetermined marking the road surface marking is.

2. The road surface marking identification method according to claim 1, wherein the controller:
sets, based on the image, a probability related to the label for each pixel of the image constituting the road surface marking;
for each road surface marking:
determines a weight coefficient for each label and predetermined marking;
calculates an evaluation value for each predetermined marking by multiplying a confidence level calculated based on the probability related to the label identifying the predetermined marking by a sum for each predetermined marking obtained by summing products of the number of pixels and the weight coefficient for each label; and
outputs a class corresponding to the predetermined marking with the largest evaluation value.

3. The road surface marking identification method according to claim 2, wherein
the controller sets the label and the probability for each pixel of the image constituting the road surface marking based on output values output for each pixel of the image from a learning model to which the image has been input; and
the learning model is a neural network generated through machine learning based on training image and training label set for each pixel of the training image to identify the predetermined marking.

4. The road surface marking identification method according to claim 2, wherein the controller:
determines connected region in the image based on the label set for each pixel of the image; and
extracts the connected region as the road surface markings.

5. The road surface marking identification method according to claim 2, wherein
the weight coefficient is a value obtained by changing the weight coefficient in a direction that increases a proportion of output classes matching training classes when the image is a training image, based on pairs of training image and training classes identifying which of the plurality of predetermined marking training road surface markings appearing in the training image are.

6. The road surface marking identification method according to claim 2, wherein the controller:
determines, for each road surface marking, whether multiple labels are assigned to the pixels constituting the image of the road surface marking; and
calculates the evaluation value only for road surface markings determined to have multiple label.

7. The road surface marking identification method according to claim 6, wherein the controller:
determines, for each road surface marking, whether the label assigned to the pixels constituting the image of the road surface marking are specific label; and
calculates the evaluation value only for road surface markings determined to have label that are specific label.

8. The road surface marking identification method according to claim 7, wherein
the weight coefficient related to the specific label is greater than a predetermined threshold.

9. The road surface marking identification method according to claim 7, wherein the controller:
determines the specific label based on road information around the vehicle.

10. The road surface marking identification method according to claim 2, wherein the controller:
uses a maximum value among the probability related to the label as the confidence level for each road surface marking and label.

11. A road surface marking identification device comprising:
a controller that identifies which of a plurality of predetermined marking a road surface marking appearing in an image is, wherein
the image is captured by an imager that captures surroundings of a vehicle,
the controller:
sets, based on the image, a label identifying a predetermined marking for each pixel of the image constituting the road surface marking;
in a region of the road surface marking:
calculates a number of pixels for each label that have been set;
calculates an evaluation value for each predetermined marking based on a relationship between the number of pixels for each of different labels included in an area of the road surface marking; and
identifies, based on the evaluation value, which of the predetermined marking the road surface marking is.
